(19) United States
(12) Patent Application Publication
(10) Pub. No.: US 2022/0184567 A1
(43) Pub. Date: Jun. 16, 2022

(54) Mixer, Exhaust System and Mixing Method

(71) Applicant: Faurecia Emission Control Technologies (Shanghai) Co., Ltd, Shanghai (CN)

(72) Inventor: Ludovic GEANT, Shanghai (CN)

(21) Appl. No.: 17/522,581

(22) Filed: Nov. 9, 2021

(30) Foreign Application Priority Data
Nov. 9, 2020 (CN) 202011241104.3

(51) Int. Cl. B01F 25/314; F01N 3/28; F01N 3/20; B01F 23/213; B01F 25/434; B01D 53/94

(52) U.S. Cl. CPC B01F 25/3141; F01N 3/2892; F01N 3/2066; F01N 2610/02; B01F 25/434; B01D 53/9431; F01N 2610/1453; B01F 23/213

(57) ABSTRACT

The present disclosure relates to a mixer, an exhaust system and a mixing method. The mixer comprises a shell, defining a first space, wherein the shell has a first opening; a mounting seat, mounted on the first opening, for mounting a doser; a swirling body, located in the first space, wherein the swirling body defines a mixing chamber, and there is a axial gap between one end of the swirling body and the mounting seat, forming a first axial gap area; and the side wall of the swirling body has a plurality of second openings distributed along the circumferential direction, wherein the second opening is mounted with a swirling component; and a rib, wherein the rib encloses the first axial gap area in the circumferential direction.

### TECHNICAL FIELD

The present disclosure relates to the field of vehicle exhaust aftertreatment, and in particular to a mixer, an exhaust system and a mixing method.

### BACKGROUND ART

The engine exhaust system treats the hot exhaust generated by the engine by various upstream exhaust components to reduce emissions pollutants. Various upstream exhaust components may include one or more of the following components: tubes, filters, valves, catalysts, muffler and so on. For example, the upstream exhaust components guide the exhaust to a selective catalytic reduction (SCR) catalyst having an inlet and outlet, and the outlet will output the exhaust to downstream exhaust components. A mixer is positioned upstream of the inlet of the SCR catalyst. In the mixer, the exhaust generates a swirling movement. A doser is used to inject a reducing agent such as a urea solution on the upstream of the SCR catalyst to the exhaust so that the mixer can fully mix the urea and the exhaust together and output to the SCR catalyst to run the reduction reaction producing nitrogen and water, so as to reduce the nitrogen oxide emission of the engine. The doser can be mounted on a mounting seat of the mixer, to inject the urea solution into the mixer.

In the mixer, the urea solution spray droplets injected from the doser need to sufficiently decompose and uniformly mix with the exhaust, so as to avoid urea deposit, and the mixer should also generate sufficient swirling movement, to provide a uniform mixing flow on the surface of the catalyst in the SCR catalyst, to optimize the efficiency of the system. To optimize the mixing effect of the mixer, a swirling body can be arranged inside the mixer, and the exhaust gas can form a swirling flow through the swirling component of the swirling body and enter the mixing chamber defined by the swirling body, mixing with the urea solution spray injected into the mixing chamber.

But in the process of completing the present disclosure, the inventor found that the swirling body of the mixer cannot be directly welded to the mounting seat, that is because the welded connection cannot meet the requirement of the thermal stress fatigue life, and due to the vehicle vibration load (for example caused by the engine, or road), the durability of the welded connection is also not able to meet the requirement, so there should be a gap between the swirling body and the mounting seat. However, the inventor further found that the gap can result in the mixing effect of the mixer being unable to meet the requirements, affecting the reaction efficiency in the SCR catalyst.

### SUMMARY

One objective of the present disclosure is to provide a mixer.

Another objective of the present disclosure is to provide an exhaust system.

Yet another objective of the present disclosure is to provide a mixing method.

A mixer according to one aspect of the present disclosure is for use in a vehicle exhaust system. The mixer comprises: a shell, defining a first space, wherein the shell has a first opening; a mounting seat, mounted on the first opening, for mounting a doser; a swirling body, located in the first space, wherein the swirling body defines a mixing chamber, and there is a axial gap between one end of the swirling body and the mounting seat, forming a first axial gap area; and the side wall of the swirling body has a plurality of second openings distributed along the circumferential direction, wherein the second opening is mounted with a swirling component; and a rib, wherein the rib encloses the first axial gap area in the circumferential direction.

In one or more embodiments of the mixer, the swirling body is a swirling cone, and the axial gap between the smaller end of the swirling cone and the mounting seat forms the first axial gap area.

In one or more embodiments of the mixer, the rib extends in the axial direction to partially overlap with the side wall of the swirling body in the axial direction.

In one or more embodiments of the mixer, the inner wall of the rib is parallel to the side wall of the swirling body, or the inner wall of the rib is parallel to the axial direction.

In one or more embodiments of the mixer, the rib comprises a first rib and a second rib, and the first rib encloses the first axial gap area in the circumferential direction; and the mounting seat has a third opening, and the radial size of the third opening is smaller than the radial size of the one end of swirling body, and the second rib is arranged on the radial gap between the third opening and the swirling body.

In one or more embodiments of the mixer, the swirling component is a swirling vane, and the number of the second openings is 6-12, and each second opening is correspondingly provided with the swirling vane, and the exhaust gas flow rate of each second opening is equal, and the exhaust gas flow rate of the first axial gap area is less than 25% of the exhaust gas flow rate of a single second opening.

In one or more embodiments of the mixer, the shell is cylindrical, and the side wall of the shell has the first opening, and one bottom surface of the shell is the inlet of the mixer, and the other bottom surface of the shell is the outlet, and a partition is arranged inside the shell to separate the two bottom surfaces of the shell, and the partition has a fourth opening, and the other end of the swirling body is installed on the fourth opening.

In one or more embodiments of the mixer, the partition comprises a first section, a second section, and a third section connected in sequence, and the second section has the fourth opening, and the first section extends from its one end on the side wall of the shell to its the other end connected to the second section, and the third section extends from its one end on the second section to its the other end on the side wall of the shell.

An exhaust system according to another aspect of the present disclosure comprises any one of the mixers as described above, and a doser, wherein the doser is mounted on the mounting seat, and is able to spray a reducing agent solution through the one end of the swirling body into the mixing chamber.

In one or more embodiments of the exhaust system, the reducing agent solution is a urea solution.

A mixing method according to yet another aspect of the present disclosure is for mixing an exhaust gas and a reducing agent spray. The mixing method comprises: the reducing agent spray entering a mixing chamber through one end of the mixing chamber; the exhaust gas forming a swirling flow on the side wall of the mixing chamber and entering the mixing chamber from openings of the side wall; a flow blocker preventing the exhaust gas from entering the mixing chamber through the one end of the mixing chamber; and the reducing agent spray being mixed with the swirling exhaust gas in the mixing chamber.

The present disclosure may include, but is not limited to, the beneficial effects that: through the setting of the rib, the structure having an axial gap between the swirling body and the mounting seat can also meet the requirement of uniform mixing of the reducing agent and the exhaust gas, ensuring a good aftertreatment of the nitrogen oxide of the exhaust system. Meanwhile, due to the setting of the rib, the standard for the size tolerance of the axial gap is relatively lower, thereby lowering the standard for the accuracy of the cumulative processing error of the manufacturing process, thereby reducing the manufacturing cost of the mixer.

### BRIEF DESCRIPTION OF THE DRAWINGS

The above-mentioned and other features, properties and advantages of the present disclosure will become more apparent from the following description in conjunction with the accompanying drawings and the embodiments. It is to be noted that the accompanying drawings are merely examples, which are not drawn to scale, and should not be construed as limiting the scope of protection actually claimed by the present disclosure, and in the accompanying drawings:

FIG. 1 to FIG. 3 are structural schematic diagrams of a mixer according to a first embodiment.

FIG. 4 is a partial structural schematic diagram of a swirling body and a mounting seat according to the first embodiment.

FIG. 5 is a structural schematic diagram of the mounting seat according to the first embodiment.

FIG. 6 is a partial structural schematic diagram of a swirling body and a mounting seat according to a second embodiment.

FIG. 7 is a structural schematic diagram of the mounting seat according to the second embodiment.

FIG. 8 is a partial structural schematic diagram of a swirling body and a mounting seat according to a third embodiment.

FIG. 9 is a structural schematic diagram of the mounting seat according to the third embodiment.

FIG. 10 is a partial structural schematic diagram of a swirling body and a mounting seat according to a fourth embodiment.

FIG. 11 is a structural schematic diagram of the mounting seat according to the fourth embodiment.

FIG. 12 is a flow diagram of a mixing method according to one embodiment.

FIG. 13 is a structural schematic diagram of an exhaust system according to one embodiment.

FIG. 14 and FIG. 15 are diagrams of simulation result of flow distribution in the mixing chamber with and without the rib.

### DETAILED DESCRIPTION

Various different implementations or embodiments carrying out the subject matter and technical solutions are disclosed as follows. Specific examples of various elements and arrangements are described below for the purpose of simplifying the disclosure, and of course, these are merely examples and are not intended to limit the scope of protection of the present disclosure.

In addition, the expressions “one embodiment”, “an embodiment” and/or “some embodiments” are intended to mean a certain feature, structure, or characteristic associated with at least one embodiment of the present application. Hence, it should be emphasized and noted that “an embodiment” or “one embodiment” or “one or more embodiments” mentioned in two or more different positions in this specification does not necessarily refer to the same embodiment. Furthermore, some of the features, structures, or characteristics of one or more embodiments of the present application can be combined as appropriate.

It needs to be explained that, if there is no description in particular, the axial, radial, and circumferential direction of the following embodiments refer to the axial, radial, and circumferential direction of the swirling body inside the mixer.

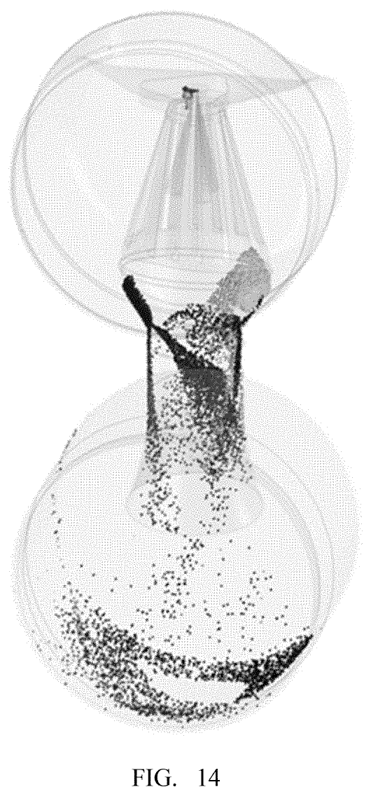

As shown in FIG. 13, the exhaust aftertreatment system 100 can comprise a mixer 10, a doser 20, an SCR catalyst 30, and the doser 2 can inject a reducing agent solution such as a urea solution into the mixer 1 and fully mixed with the exhaust and then output from the mixer 10 to the SCR catalyst 30 performing a reaction, transforming the nitrogen oxides of the exhaust into nitrogen and water. Currently, the reducing agent solution is typically the urea solution, and so in the following embodiments the reducing agent solution will be described as a urea solution.

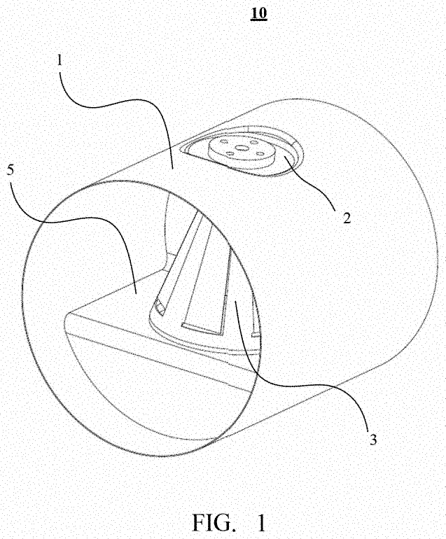

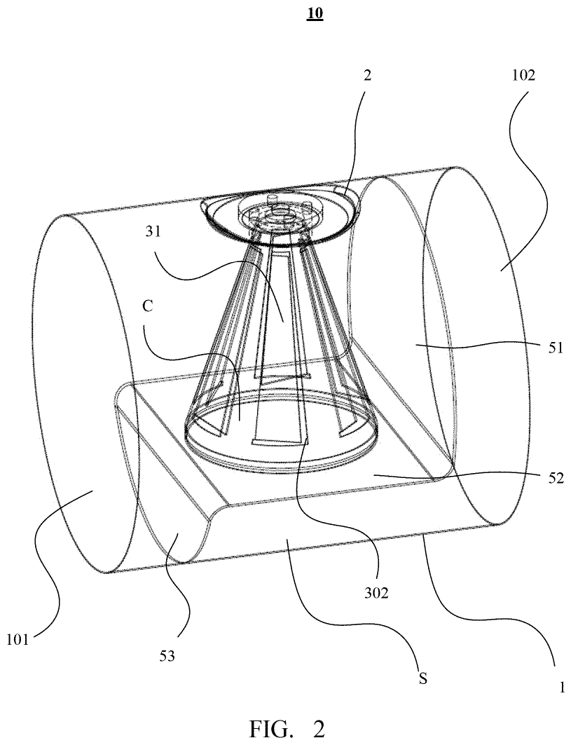

With reference to FIG. 1 to FIG. 3, in some embodiments, the mixer 1 comprises a shell 1, a mounting seat 2, and a swirling body 3. The shell 1 defines a first space S, and the shell 1 has a first opening 11. The mounting seat 2 is mounted on the first opening 11, and the doser (not shown) is mounted on the mounting seat 2. In detail, it can be seen from FIG. 1 to FIG. 3, that the shell 1 is cylindrical, and its side wall has a first opening 11, and the mounting seat 2 is mounted on the side wall of the shell 1. A first bottom surface 101 of the shell 1 is an opening, being the inlet of the mixer 10, and a second bottom surface 102 is also an opening, being the outlet of the mixer 10. The swirling body 3 is located in the first space S, and defines a mixing chamber C. As shown in FIG. 4, there is a axial gap G1 between one end 301 of the swirling body 3 and the mounting seat 2, forming a first axial gap area A1, and the side wall of the swirling body has a plurality of second openings 302 distributed along the circumferential direction, and the second opening 302 is mounted with a swirling component 31. As shown in FIG. 4, a specific structure of the swirling component 31 can be a swirling vane. A very large part of the exhaust gas will enter the mixing chamber C through the second openings 302, forming a swirling by the swirling component 31, and a very small part of the exhaust gas will enter the mixing chamber C through the first axial gap area A1 and the one end 301 of the swirling body 3.

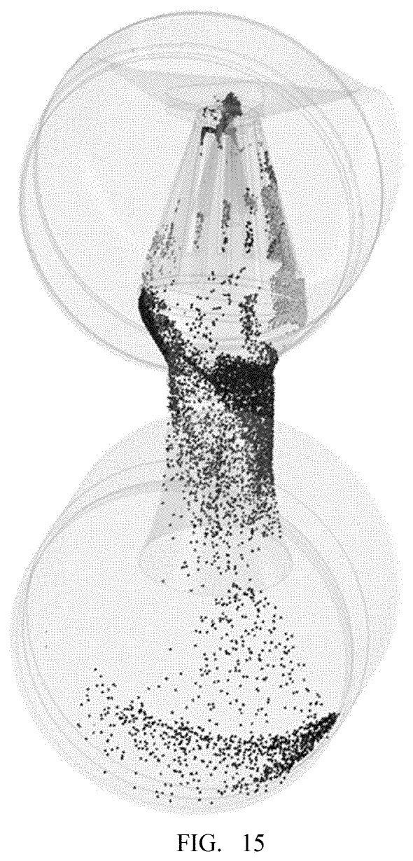

The exhaust gas entering the mixing chamber C will be fully mixed with the urea spray injected by the doser. As shown in FIG. 3 and FIG. 4, the mixer 10 further comprises a rib 4, and the rib 4 encloses the first axial gap area A1 in the circumferential direction, so that the part of exhaust gas that goes through the first axial gap area A1, should climb the height of the rib 4 to reach the first axial gap area A1. Because the rib 4 encloses the first axial gap area A1 in the circumferential direction, the exhaust gas is hardly to follow a second flow path R2 shown in FIG. 4 to directly enter the first axial gap area A1, in other words, the exhaust gas is hardly to directly enter the first axial gap area A1 in the radial direction, and should go underneath, such as following a first flow path R1, entering through the radial gap between the swirling body 3 and the mounting seat 2. The beneficial effects of the above-mentioned embodiments lie in that making the structure meet the requirement of uniform mixing of the reducing agent and the exhaust gas even when there is an axial gap G1 between the swirling body 3 and the mounting seat 2, ensuring a good aftertreatment of the nitrogen oxide of the exhaust system. And the reason is that, the inventors found that, as shown in FIG. 14 and FIG. 15, comparing the simulation results of the rib 4 being not set to let the exhaust gas follow the second flow path R2 to directly enter the first axial gap area A1 in FIG. 14 and the rib 4 being set in FIG. 15, it can be found that, in FIG. 15, the mixing positions of the urea spray and the exhaust gas are mainly on the side wall of the swirling body 3, meaning that the mixing of the urea spray and the swirling exhaust gas is uniform. However, in FIG. 14, smaller part of the mixing positions of the urea spray and the exhaust gas are on the side wall of the swirling body 3, and larger part of the mixing positions are around the axis, meaning that the mixing of the urea spray and the swirling exhaust gas is not uniform enough.

Moreover, the inventors further found that, when the rib 4 is not set, even the axial gap G1 is set to a very small amount, such as 2 mm, there is still plenty of exhaust gas (in some cases, can be as much as the exhaust gas flow of a single second opening 302) following the first flow path R1 to directly enter the first axial gap area A1. It can be understood that the axial gap G1 can hardly be smaller, otherwise there will be no room for the cumulative processing error of the manufacturing process.

With continued reference to FIG. 1 to FIG. 5, one specific shape of the swirling body 3 can be a cone shape, so the swirling body 3 is a swirling cone. The one end 301 is the smaller end of the swirling cone, and the smaller end of the swirling cone and the mounting seat 2 form the first axial gap area A1. The cone shape is able to match the shape of the urea spray, reaching a better mixing result of the exhaust gas and the urea spray. But it can be understood that the shape of the swirling body 3 is not limited to the cone shape, for example, it can also be a cylinder shape, a prism shape, or even a sphere shape, and so on.

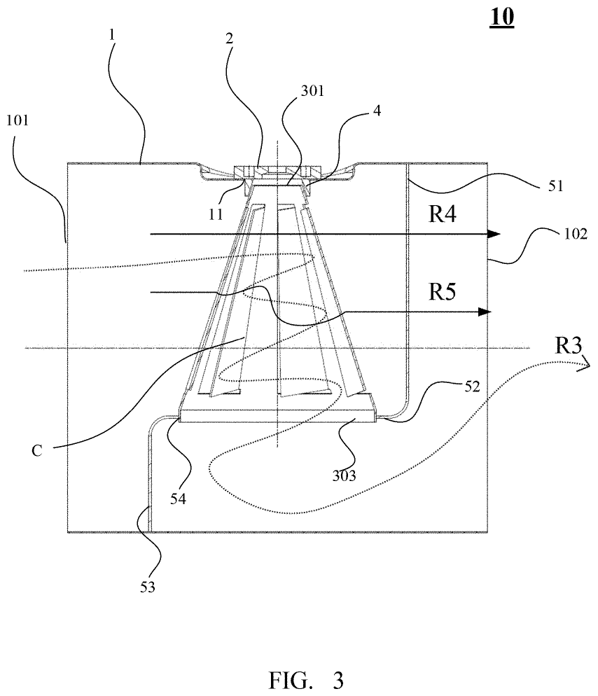

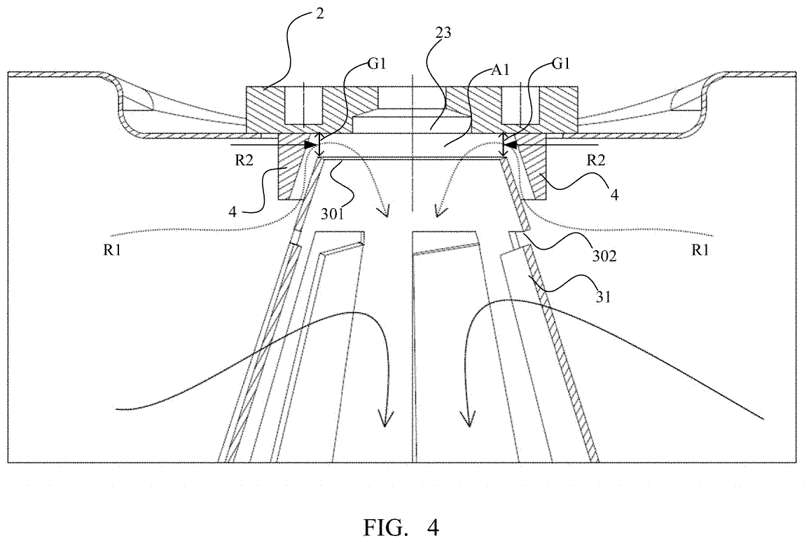

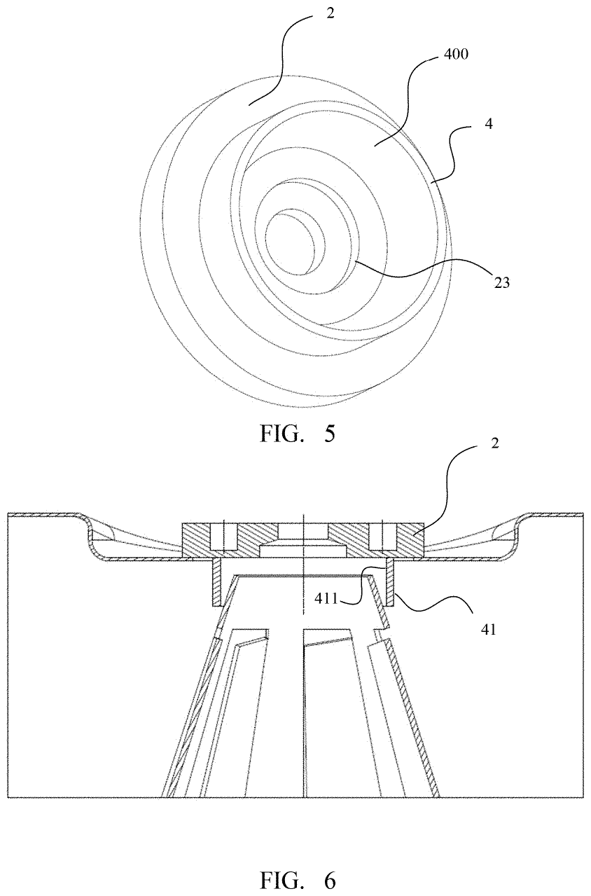

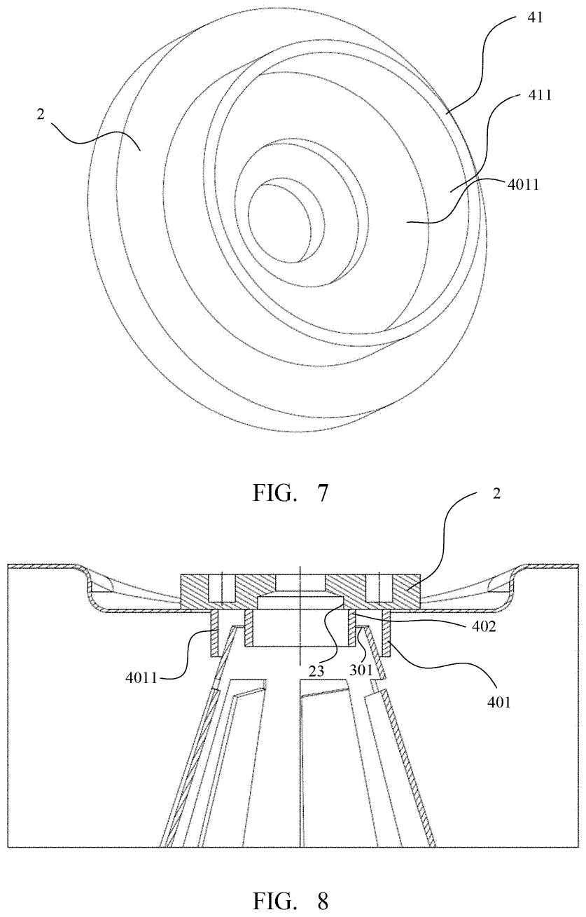

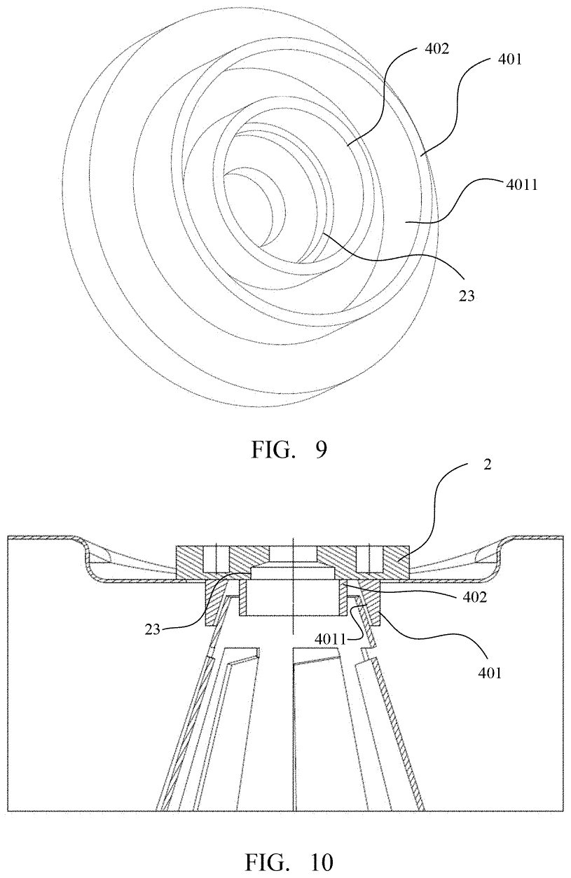

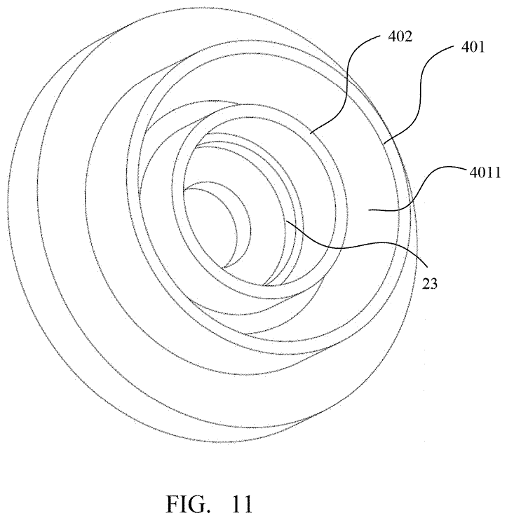

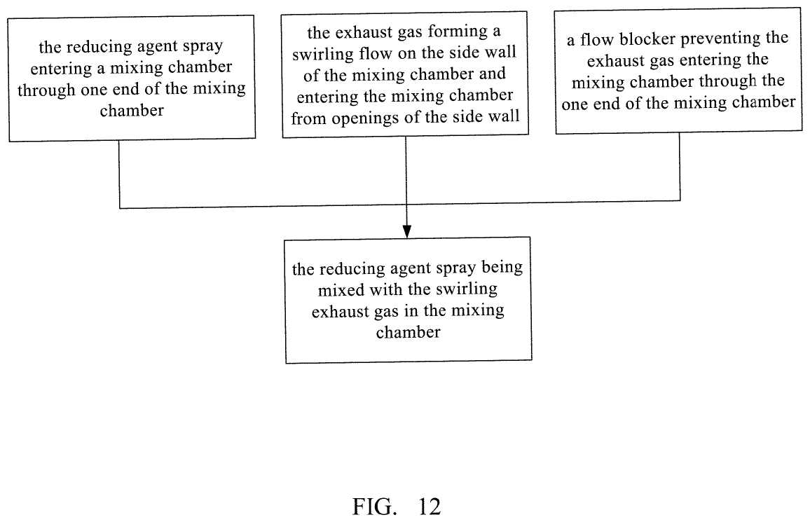

With reference to FIG. 6 to FIG. 11, as shown in the second, the third and the fourth embodiment, the structure of the rib 4 is not limited to the structure shown in FIG. 4 and FIG. 5. For example, in the second embodiment shown in the FIG. 6 and FIG. 7, the inner wall 411 of the rib 41 is parallel to the axial direction, compared with the first embodiment showed in FIG. 4 and FIG. 5 that the inner wall 400 of the rib 4 is parallel to the side wall of the swirling cone. For example, it can also be as shown in FIG. 8 and FIG. 9, the rib comprises a first rib 401 and a second rib 402, and the first rib 401 encloses the first axial gap area A1 in the circumferential direction; and the radial position of the second rib 402 is arranged on the radial gap between a third opening 23 and the one end 301 of the swirling body 3, that is to say, the second rib 402 is configured to be in the first axial gap area A1, so that to make the part of exhaust gas that goes through the first axial gap area A1 entering the mixing chamber C at most enter at the circumferential edge of the one end 301, to further lessen the exhaust gas to enter the mixing chamber through the one end 301, and at the same time, make the part of the exhaust gas that goes through the first axial gap area A1 be close to the side wall of the swirling body 3, to further improve the mixing result of the urea spray and the exhaust gas. But it can be understood that, setting two ribs will cost more than setting one rib. Similarly, in the third embodiment and the fourth embodiment, the inner wall 4011 of the first rib 401 can be parallel to the swirling cone, or can be parallel to the axial direction. By setting different structure and different number of the rib, the flow rate of the exhaust gas that goes through the first axial gap area A1 and the one end 301 can be flexibly adjusted, reaching a uniform mixing of the urea and the exhaust gas.

With reference to FIG. 3 to FIG. 11, the extension length of the rib can be that the rib extends in the axial direction to partially overlap with the side wall of the swirling body 3 in the axial direction. That is to say, the rib 4, or the rib 41, or the rib 401 fully encloses the first axial gap area A1 in the circumferential direction, so the structure of the rib is simple. But the structure is not limited to the above-mentioned one, it can be a more complicated structure, for example, the extension length is relatively smaller, for example, the first rib 401 extends to the axial position of the one end 301 or even smaller, meanwhile the extension length of the second rib 402 is relatively greater, so that to make the gap between the first rib 401 and the side wall of the swirling body 3 bigger, lowering the standard for the accuracy of the cumulative processing error of the manufacturing process. Similarly, the extension length of the rib in the circumferential direction can be, as shown in FIG. 3 to FIG. 11, the rib extends to form a full circle in the circumferential direction, but also can be, a rib extends to form a part circle, meanwhile setting multiple ribs in the radial direction. In addition, as shown in FIG. 4 to FIG. 11, the rib can be integrated with the mounting seat 2, but not limited to this, for example, the rib can also be integrated with the shell 1.

Furthermore, in the embodiments shown in FIG. 1 to FIG. 11, the number of the second openings is 6-12, and each second opening 302 is correspondingly provided with the swirling component 31, and in the embodiments the swirling vane, and the exhaust gas flow rate of each second opening 302 is equal. The inventors found that, the flow rate of the part of the exhaust gas that goes through the first axial area A1 entering the mixing chamber C should be limited to lower than about 25% of the exhaust gas flow rate of a single second opening 302. Take the number of the second openings is 12 as an example, the flow rate of each second opening 302 is about 8% of the total exhaust gas, and the inventor found that, when the rib is not set, even the flow rate of the part of the exhaust gas that goes through the first axial area A1 entering the mixing chamber C is only 2.9% of the total exhaust gas, the mixing result of the urea and the exhaust gas is still not good enough. When the rib is set, the flow rate of the part of the exhaust gas that goes through the first axial area A1 entering the mixing chamber C can be limited to only 1.8% of the total exhaust gas, reaching a relatively good mixing result. But when the number of the second openings is 8, and the flow rate of each second opening 302 is about 12% of the total exhaust gas, the setting of the rib can also reach a relatively good mixing result, even the flow rate of the part of the exhaust gas that goes through the first axial area A1 entering the mixing chamber C is 3% of the total exhaust gas.

With continued reference to FIG. 1 to FIG. 3, one specific position of the swirling body 3 in the first space S of the shell can be, a partition 5 is also arranged inside the shell 1, and the partition 5 separates the first bottom surface 101 and the second bottom surface 102 of the shell 1, the ‘separate’ here can be meant to make the first bottom surface 101 and the second bottom surface 102 not in direction connection, that is to say, when a person wants to view from one of the first bottom surface 101 and the second bottom surface 102 to the other one, that person cannot see the other one.

The partition 5 comprises a fourth opening 54, and the other end 303 of the swirling body 3, or the bigger end when the swirling body 3 is the swirling cone, is mounted on the partition 5. The beneficial effect can be seen from the FIG. 3, the flow of exhaust gas and the mixture of the exhaust gas and the urea spray is a third flow path R3, on which the exhaust gas entering the shell 1 through the first bottom surface 101, entering the swirling body 3, exiting through the other end 303 of the swirling body, and exiting through the second bottom surface 102, to further improve the mixing result of the urea spray and the exhaust gas. When the partition 5 is not set, as shown in FIG. 3, it can be that the flow path of one part of the exhaust gas is a fourth flow path R4, on which the exhaust gas entering the swirling body 3 through the side wall of it, and straight exiting through the side wall, and then exiting through the second bottom surface 102, and the flow path of one part of the exhaust gas is a fifth flow path R5, on which the exhaust gas entering the swirling body 3 through the side wall of it and forming a swirling gas, then exiting through the side wall, and then exiting through the second bottom surface 102. Following the fourth flow path R4 and the fifth flow path R5 will both cause a bad mixing result of the one part of the exhaust gas and the urea spray. However, when the partition 5 is set, even the exhaust gas exiting through the side wall, due to the blocking of the partition 5, the exited exhaust gas can reenter the mixing chamber C through the side wall. With reference to FIG. 1 to FIG. 3, one specific structure of the partition 5 can be that it comprises a first section 51, a second section 52, and a third section 53 connected in sequence, and the second section 52 has the fourth opening 54, and the first section 51 extends from its one end on the side wall of the shell 1 to its the other end connected to the second section 52, and the fourth opening 54 is connected with the other end 303 of the swirling body 3, and the third section 53 extends from its one end on the second section 52 to its the other end on the side wall of the shell 1, separating the two bottom surfaces of the shell 1. The above-mentioned partition 5 is of a simple structure, easy to be manufactured and to be mounted in the first space S of the shell 1, and able to offer a stable fixing to the swirling body 3.

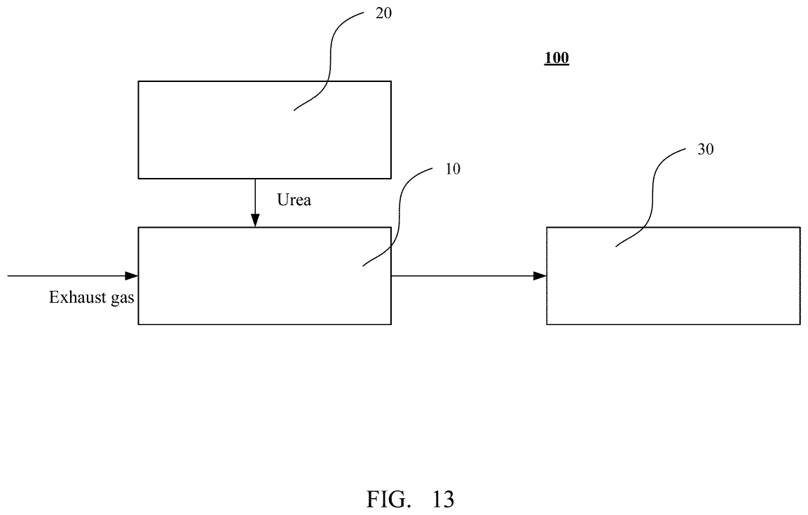

It can be concluded from above, and with reference to FIG. 12, that a mixing method for mixing an exhaust gas and a urea spray from the above-mentioned embodiments comprises:

the reducing agent spray entering a mixing chamber through one end of the mixing chamber; for example, from the above introduction, the urea spray entering the mixing chamber C through the one end 301 of the swirling body 3;

the exhaust gas forming a swirling flow on the side wall of the mixing chamber and entering the mixing chamber from openings of the side wall; for example, from the above introduction, the exhaust gas entering through the second openings 302 of the side wall of the swirling body 3, and a swirling vane is correspondingly set on the second opening 302, to make the exhaust gas form a swirling flow, entering the mixing chamber through the second openings 302;

a flow blocker preventing the exhaust gas from entering the mixing chamber through the one end of the mixing chamber; or example, from the above introduction, the rib 4 is set to enclose the first axial gap area A1 in the circumferential direction, to lessen the part of the exhaust gas that goes through the first axial gap area A1 and the one end 301 entering the mixing chamber C;

the reducing agent spray being mixed with the swirling exhaust gas in the mixing chamber C.

It can be seen from the above that by using the mixer, the exhaust system and the mixing method described in the above embodiments, the beneficial effects lie in that through the setting of the rib, the structure having an axial gap between the swirling body and the mounting seat can also meet the requirement of uniform mixing of the reducing agent and the exhaust gas, ensuring a good aftertreatment of the nitrogen oxide of the exhaust system. Meanwhile, due to the setting of the rib, the standard for the size tolerance of the axial gap is relatively lower, thereby lowering the standard for the accuracy of the cumulative processing error of the manufacturing process, thereby reducing the manufacturing cost of the mixer.

Although the present disclosure has been disclosed as the above embodiments which, however, are not intended to limit the present disclosure, any person skilled in the art could make possible changes and alterations without departing from the spirit and scope of the present disclosure. Hence, any alteration, equivalent change and modification which are made to the above-mentioned embodiments in accordance with the technical essence of the present disclosure without departing from the contents of the technical solutions of the present disclosure would all fall within the scope of protection defined by the claims of the present disclosure.

### REFERENCE NUMERALS

100—Exhaust system
10—Mixer
20—Doser
30—SCR catalyst
1—Shell
11—First opening
111—First bottom surface
112—Second bottom surface
2—Mounting seat
23—Third opening
3—Swirling body
302—Second Opening
301—One end
303—The other end
31—Swirling component
4, 41—Rib
400, 401—Inner wall
401—First rib
402—Second rib
5—Partition
51—First section
52—Second section
53—Third section
54—Fourth opening

1. A mixer for use in a vehicle exhaust system, the mixer comprising:
a shell, defining a first space, wherein the shell has a first opening;
a mounting seat, mounted on the first opening, for mounting a doser;
a swirling body, located in the first space, wherein the swirling body defines a mixing chamber, and there is an axial gap between one end of the swirling body and the mounting seat, forming a first axial gap area; and the side wall of the swirling body has a plurality of second openings distributed along the circumferential direction, wherein the second opening is mounted with a swirling component; and
a rib, wherein the rib encloses the first axial gap area in the circumferential direction.

2. The mixer of claim 1, wherein the swirling body is a swirling cone, and the axial gap between the smaller end of the swirling cone and the mounting seat forms the first axial gap area.

3. The mixer of claim 1, wherein the rib extends in the axial direction to partially overlap with the side wall of the swirling body in the axial direction.

4. The mixer of claim 3, wherein the inner wall of the rib is parallel to the side wall of the swirling body, or the inner wall of the rib is parallel to the axial direction.

5. The mixer of claim 1, wherein the rib comprises a first rib and a second rib, and the first rib encloses the first axial gap area in the circumferential direction; and the mounting seat has a third opening, and the radial size of the third opening is smaller than the radial size of the one end of swirling body, and the second rib is arranged on the radial gap between the third opening and the swirling body.

6. The mixer of claim 1, wherein the swirling component is a swirling vane, and the number of the second openings is 6-12, and each second opening is correspondingly provided with the swirling vane, and the exhaust gas flow rate of each second opening is equal, and the exhaust gas flow rate of the first axial gap area is less than 25% of the exhaust gas flow rate of a single second opening.

7. The mixer of claim 1, wherein the shell is cylindrical, and the side wall of the shell has the first opening, and one bottom surface of the shell is the inlet of the mixer, and the other bottom surface of the shell is the outlet, and a partition is arranged inside the shell to separate the two bottom surfaces of the shell, and the partition has a fourth opening, and the other end of the swirling body is installed on the fourth opening.

8. The mixer of claim 7, wherein the partition comprises a first section, a second section, and a third section connected in sequence, and the second section has the fourth opening, and the first section extends from its one end on the side wall of the shell to its the other end connected to the second section, and the third section extends from its one end on the second section to its the other end on the side wall of the shell.

9. An exhaust system, comprising a mixer and a doser, wherein the mixer comprises:
a shell, defining a first space, wherein the shell has a first opening;
a mounting seat, mounted on the first opening, for mounting a doser;
a swirling body, located in the first space, wherein the swirling body defines a mixing chamber, and there is a axial gap between one end of the swirling body and the mounting seat, forming a first axial gap area; and the side wall of the swirling body has a plurality of second openings distributed along the circumferential direction, wherein the second opening is mounted with a swirling component; and
a rib, wherein the rib encloses the first axial gap area in the circumferential direction;
wherein the doser is mounted on the mounting seat, and is able to spray a reducing agent solution through the one end of the swirling body into the mixing chamber.

10. The exhaust system of claim 9, wherein the swirling body is a swirling cone, and the axial gap between the smaller end of the swirling cone and the mounting seat forms the first axial gap area.

11. The exhaust system of claim 9, wherein the rib extends in the axial direction to partially overlap with the side wall of the swirling body in the axial direction.

12. The exhaust system of claim 11, wherein the inner wall of the rib is parallel to the side wall of the swirling body, or the inner wall of the rib is parallel to the axial direction

13. The exhaust system of claim 9, wherein the rib comprises a first rib and a second rib, and the first rib encloses the first axial gap area in the circumferential direction; and the mounting seat has a third opening, and the radial size of the third opening is smaller than the radial size of the one end of swirling body, and the second rib is arranged on the radial gap between the third opening and the swirling body.

14. The exhaust system of claim 9, wherein the swirling component is a swirling vane, and the number of the second openings is 6-12, and each second opening is correspondingly provided with the swirling vane, and the exhaust gas flow rate of each second opening is equal, and the exhaust gas flow rate of the first axial gap area is less than 25% of the exhaust gas flow rate of a single second opening.

15. The exhaust system of claim 9, wherein the shell is cylindrical, and the side wall of the shell has the first opening, and one bottom surface of the shell is the inlet of the mixer, and the other bottom surface of the shell is the outlet, and a partition is arranged inside the shell to separate the two bottom surfaces of the shell, and the partition has a fourth opening, and the other end of the swirling body is installed on the fourth opening.

16. The exhaust system of claim 15, wherein the partition comprises a first section, a second section, and a third section connected in sequence, and the second section has the fourth opening, and the first section extends from its one end on the side wall of the shell to its the other end connected to the second section, and the third section extends from its one end on the second section to its the other end on the side wall of the shell.

17. The exhaust system of claim 9, wherein the reducing agent solution is a urea solution.

18. A mixing method, for mixing an exhaust gas and a reducing agent spray, the mixing method comprising:
the reducing agent spray entering a mixing chamber through one end of the mixing chamber;
the exhaust gas forming a swirling flow on the side wall of the mixing chamber and entering the mixing chamber from openings of the side wall;
a flow blocker preventing the exhaust gas entering the mixing chamber through the one end of the mixing chamber; and
the reducing agent spray being mixed with the swirling exhaust gas in the mixing chamber.
